(19) United States
(12) Patent Application Publication
(10) Pub. No.: US 2016/0083301 A1
(43) Pub. Date: Mar. 24, 2016

(54) PCBN MATERIAL, TOOL ELEMENTS COMPRISING SAME AND METHOD FOR USING SAME

(71) Applicant: ELEMENT SIX LIMITED, County Clare (IE)

(72) Inventors: Anna SJÖGREN, Robertsfors (SE); Lars-Ivar NILSSON, Robertsfors (SE)

(21) Appl. No.: 14/890,384

(22) PCT Filed: May 30, 2014
(86) PCT No.: PCT/EP2014/061292

§ 371 Date: Nov. 10, 2015

(30) Foreign Application Priority Data
May 31, 2013 (GB) 1309782.9

(51) Int. Cl. C04B 35/5831; C04B 35/645

(52) U.S. Cl. CPC C04B 35/5831; C04B 35/645; C04B 2235/785; C04B 2235/786

(57) ABSTRACT

PCBN material comprising at least 30 volume per cent cubic boron nitride (cBN) grains (10) bonded together by a matrix comprising aluminium nitride (20), and a plurality of regions (30) comprising boron and aluminium atoms, in which regions there are at least 15 times more boron atoms than aluminium atoms present. The regions comprise an aluminium boride phase of the inorganic chemical formula Al xBy, where x is at least 0.8 and at most 1.2, and y is at least 15, the ratio y:x being at least 15. The cubic boron nitride ceramic has been made by mixing cBN and Al grains and sintering at at least 1500 degrees Celcius and 4.5 GPa.

This disclosure relates to generally to PCBN material and tool elements comprising same, particularly but not exclusively for machining work-pieces comprising metal.

U.S. Pat. No. 4,666,466 discloses an abrasive compact comprising a mass of cubic boron nitride (cBN) grains and a second phase bonded into a hard conglomerate, in which adjacent cBN grains are joined to each other to form an inter-grown mass. The cBN content of the compact is at least 80 per cent by weight and the second phase consisting essentially of aluminium nitride and or aluminium diboride. A method for making the compact is also disclosed, the method including placing a mass of cBN grains in contact with a mass of aluminium to form a reaction mass, placing the reaction mass in a reaction zone, raising the pressure of the reaction zone to a pressure in the range 5.0 to 6.5 gigapascals (GPa) and the temperature to within the range 1,400 to 1,600 degrees Celsius, for a time sufficient to produce a sintered compact.

U.S. Pat. No. 8,148,282 discloses cubic boron nitride (cBN) composite comprising about 91 to 94 mass per cent cBN grains within an aluminium-based non-cBN matrix. During the sintering process, molten aluminium metal is allowed to react with the cBN grains until the aluminium is completely converted to AlN (aluminium nitride) and AlB₂ (aluminium diboride) in the resulting sintered compact. Other reaction products such as AlB₆ (aluminium hexaboride) and AlB₁₂ (aluminium dodecaboride) are possible in principle, which would have the effect of reducing the cBN content in the final compact and are described as being generally undesirable. It is disclosed that no evidence of these higher order aluminium borides was found.

There is a need for PCBN material and tools comprising PCBN material and having a good working life or performance in use, particularly but not exclusively for machining bodies comprising cast iron.

Viewed from a first aspect, there is provided PCBN material comprising at least 30 volume per cent cubic boron nitride (cBN) grains bonded together by a matrix comprising or consisting (apart from minor impurities) aluminium nitride and a plurality of regions comprising boron and aluminium atoms, in which regions there are at least 15 times more boron atoms than aluminium atoms present. In other words, the atomic ratio of the boron to the aluminium atoms present in the regions will be at least 15. The regions may also be referred to as ‘boron-rich’ regions.

Various forms, compositions, microstructures and arrangements of PCBN material are envisaged by the disclosure, non-limiting, non-exhaustive examples of which are described below.

In some examples, there may be at most about 30 or at most about 25 times more boron atoms than aluminium atoms present in the (boron-rich) regions.

The (boron-rich) regions may be said to be present in the PCBN material in the form of aluminium boride grains, which may be located interstitially, within the interstitial regions between the cBN grains. In some example microstructure arrangements, the cBN grains and the aluminium boride grains may be said to be dispersed within cementing material comprising or substantially consisting of aluminium nitride.

In some examples, the (boron-rich) regions may comprise an aluminium boride phase of the inorganic chemical formula AlₓB_{y}, where x is at least 0.8 and at most 1.2, and y is at least 15 or 16, the ratio y:x being at least 15 or 16 (in other words, in which there are at least 15 or 16 boron atoms for each aluminium atom). In some examples, y may have a mean value in the range 16 to 16.5, or y may be in the range 24 to 26. The values of x and or y may be mean values throughout a volume of the (boron-rich) regions. The aluminium boride phase may be selected from one or more of aluminium hexadecaboride (AlB₁₆) or aluminium pentacostaboride (AlB₂₅), in stoichiometric, or sub- or super-stoichiometric form.

In some examples, the (boron-rich) regions may be substantially amorphous or they may be substantially crystalline.

In some examples, the cBN content may be at least 70 volume per cent, at least 80 volume per cent or at least 90 volume per cent of the PCBN material. In some examples, the cBN content may be at most 96 volume per cent of the PCBN material.

In some examples, the content of the aluminium boride phase may be at least 1 weight per cent or at least 10 weight per cent of the PCBN material.

In some examples, the cBN grains may have a mean size of at least 0.5 microns; in some examples, the cBN grains may have a mean size of at most 10 microns, at most 8 microns or at most 5 microns. In some examples, the area distribution of cBN grains exposed at a surface of the PCBN material as a function of cBN grain size may include more than one mode.

In some examples, the PCBN material may contain less than 2 weight per cent or less than 1 weight per cent aluminium diboride (AlB₂), or it may be substantially free of aluminium diboride. There may be substantially no peak corresponding to aluminium diboride in an XRD trace of the PCBN material, within a detection limit of about 1 weight per cent.

In some examples, the (boron-rich) regions may appear in the form of microscopic grains substantially embedded within aluminium nitride material. Most or substantially all of the (boron-rich) regions may be separated from the cBN grains by cementing material comprising aluminium nitride. In some examples, less than about 10 per cent or less than about 5 per cent of the boundary path length of the (boron-rich) regions may be in contact with cBN material, when a surface of the PCBN material is viewed by microscope means; and in some examples, substantially no part of the boundary of the (boron-rich) regions may contact boundaries of the cBN grains. Most or substantially all of the surface area of the cBN grains and or of the (boron-rich) regions may be bonded to aluminium nitride material.

In some examples, the (boron-rich) regions may have a mean size of at most about 20 microns or at most about 10 microns, in terms of the distribution of segment lengths through the boron-rich regions visible on a surface of the PCBN material. The equivalent circle area distribution of the boron-rich regions as a function of segment lengths through the regions may include more than one mode. A first mode in the size distribution of the (boron-rich) regions may be at most about 5 microns or at most about 1 micron, and a second mode of the (boron-rich) regions may be greater than 5 microns.

In some examples, the PCBN material may have porosity less than 1 per cent or may be substantially free of porosity.

In some examples, the PCBN material may have microstructural composition and arrangement such that the mean speed of sound through the PCBN material is at least 14,500 metres per second (m/s), at least 14,700 m/s or at least 15,000 m/s. While wishing not to be bound by a particular theory, the speed of sound through PCBN material may provide an indication of certain aspects of its microstructure, material composition and or the strength of the bonding between the cBN grains and the binder matrix. In some examples, the speed of sound may provide an indication of the potential effectiveness of PCBN material for certain applications. In general, a relatively higher speed of sound through PCBN material may indicate that it is potentially of high quality.

In some examples, a relatively high contiguity among the cBN grains may be evident, in which a higher proportion of the cBN grain boundaries involve direct contact between cBN grains. In other words, a higher proportion of the specific surface area of the cBN grain boundaries may be associated with direct or adjacent contact between cBN grains. This microstructural arrangement may give rise to the increased speed of sound through example PCBN material according to this disclosure.

Viewed from a second aspect, there is provided a method of making PCBN material according to this disclosure, the method including a pre-sinter compact comprising an aggregation comprising a plurality of cBN grains, and a source of aluminium, the source being selected and arranged in relation to the aggregation such that molten aluminium will be available to contact the cBN grains at a sinter temperature of at least about 1,500 degrees Celsius, more than 1,600 degrees Celsius or at least about 1,650 degrees Celsius and a sinter pressure of at least about 4.5 gigapascals (GPa), subjecting the pre-sinter compact to the sinter temperature and sinter pressure for sufficient sinter period for the aluminium to react with the cBN grains to the extend that there remains substantially no non-reacted aluminium between the cBN grains and to provide a sintered PCBN structure, the sinter pressure and sinter temperature selected such that substantially no hexagonal boron nitride (hBN) arises in the sintered PCBN structure; and then decreasing the temperature and pressure to an ambient condition; the content and size distribution of the cBN grains comprised in the aggregation being such that the amount of the cBN grains in the PCBN material will be at least 30 volume per cent (or 30 mass per cent, in some examples).

Variations of the method are envisaged by the disclosure, of which the following are non-limiting and non-exhaustive examples.

In some examples, the sinter temperature may be at least about 1,650 degrees Celsius, at least about 1,700 degrees Celsius or at least about 1,800 degrees Celsius.

In some examples, the sinter pressure may be at least about 5 gigapascals (GPa) or at least about 6 gigapascals (GPa).

In some examples, the sinter period may be at least 30 seconds, at least 1 minute, at least 5 minutes, at least about 15 minutes or at least about 30 minutes. In general, longer sinter periods may be used to sinter larger volumes of the PCBN material and relatively short sinter periods may be used to sinter smaller volumes of PCBN material.

In some examples, the mass distribution as a function of equivalent circle diameter (ECD) grain size of the cBN grains comprised in the aggregation may include more than one mode.

In some examples, the mean size of the cBN grains comprised in the aggregation may be at most about 10 microns or at most about 5 microns.

In some examples, the source of aluminium may be in the form of grains of aluminium metal blended with the cBN grains comprised in the aggregation, or the source of aluminium may be in the form of a body such as a disc in contact with the aggregation.

Viewed from a third aspect, there is provided a tool comprising PCBN material according to this disclosure.

In some example, the tool may be a forming tool such as a machine tool. The tool may comprise an indexable insert for machining, such as turning, drilling or milling a body.

In some examples, the tool may comprise a PCBN structure according to this disclosure joined to a tool carrier body, for example by means of a braze alloy. In other examples, the tool may comprise a self-supporting PCBN structure that is not brazed to a tool carrier.

Viewed from a fourth aspect, there is provided a method of using a PCBN tool, including providing a cutter tool comprising a cutter edge defined by the PCBN material, and using the tool to machine a body comprising cast iron material.

Non-limiting examples will be described with reference to the accompanying drawings, of which

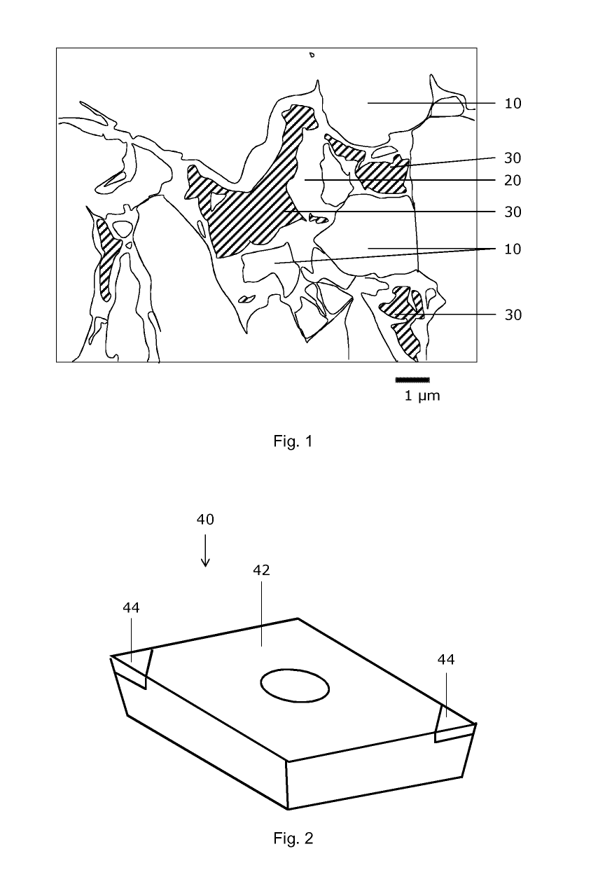

FIG. 1 shows a schematic microscopic view of a surface of example PCBN material (a 1 micron scale bar is provided);

FIG. 2 shows an example cutter insert comprising example PCBN material joined to a substrate, and

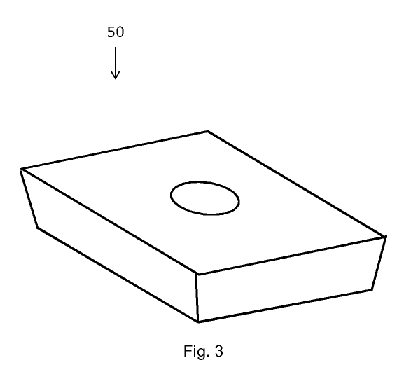

FIG. 3 shows an example cutter insert comprising example PCBN material.

With reference to FIG. 1, example PCBN material may comprise cBN grains 10 and boron-rich regions 30 cemented together within a matrix 20 comprising aluminium nitride. Apart from practically unavoidable impurities and potentially a minor amount of aluminium diboride (not shown in FIG. 1), the matrix 20 may substantially consist of aluminium nitride. Relatively much smaller boron-rich regions not shown in the illustration and having a mean size of less than 1 or 2 microns, may be dispersed within the matrix between the larger boron-rich regions 30 and the cBN grains 10, which are shown. The boron-rich regions 30 are likely to be substantially amorphous and may comprise or consist of aluminium hexadecaboride (AlB₁₆) and/or aluminium pentacostaboride (AlB₂₅), in stoichiometric or super-stoichiometric form. For example, the boron-rich regions 30 may comprise or consist of AlB_{16.3} according to energy dispersive X-ray spectroscopy (EDS) spot analysis. The boron-rich regions 30 may appear to be separated from the cBN grains by the aluminium nitride matrix 20, and located near the centres of the interstitial regions between the cBN grains 10. Less than 10 per cent or substantially none of the path length along the boundaries or the boron-rich regions 30 as viewed on a polished surface of the example PCBN material appears to contact a cBN grain 10.

With reference to FIG. 2, an example indexable cutter tool 40 may comprise a plurality of example PCBN cutter elements 44 brazed to a cemented carbide substrate 42. With reference to FIG. 3, an example cutter tool element 50 for a machine tool may be formed of example PCBN material that is not bonded to a substrate.

Non-limiting examples are described below in order to illustrate the disclosed methods and resulting materials.

All of the example and control PCBN samples were made by a method including preparing respective pre-sinter assemblies by compacting raw material aggregations to form compacted discs encapsulated within cups of a refractory material, which were assembled into a capsule for sintering PCBN material and subjected to a sinter pressure and a sinter temperature for a sinter time. In all cases, the control PCBN material was sintered at a sinter pressure of about 4 gigapascals (GPa) and a sinter temperature of about 1,250 degrees Celsius for a sinter period of about 30 minutes.

The speeds of sound in the example and control PCBN elements were measured by means of an ultra-sound technique. The speed of sound in the PCBN material is believed to provide an indication of the contiguity of the cBN grains and other phases present in which the speed or sound is relatively high. Relatively higher speeds of sounds are believed to indicate potentially superior wear resistance of ceramic materials. The speed of sound is measured by means of a scanning accoustograph device, which records the speed of longitudinal compression waves in a solid body.

The control and example PCBN materials were analysed using X-ray diffraction (XRD). The control and example PCBN material were also analysed using spot energy dispersive X-ray spectroscopy (EDS), in which the spot diameter was at most about 1 micron. The EDS measurement permitted the atomic ratio of boron to aluminium to be measured at various points on the surfaces of the materials, including within the boron-rich regions.

In all Examples described below, the example PCBN materials made according to this disclosure were found to comprise (cBN) grains bonded together by a matrix comprising aluminium nitride and regions comprising boron and aluminium atoms, in which regions there are about 15 times more boron atoms than aluminium atoms present.

### EXAMPLES 1 AND 2

Two different example PCBN materials were made and compared to a control PCBN material in terms of microstructure, composition, the speed of sound through the material and the behaviour of the material in a turning test. Two respective cutter elements consisting of each of the example PCBN materials were prepared by cutting structures from respective sintered PCBN discs and processing the structures to provide them with cutting edges. A cutter element was prepared in the same way from a sintered disc consisting of a control PCBN material.

The PCBN discs were made by blending cBN grains with aluminium (Al) powder having a mean grain size of about 6 microns, the mass content of the cBN being about 90 per cent of the blended powders and the balance consisting of the Al powder. The cBN grains for both the control and example materials were provided from the same source and had a mean size in the range of 3 to 8 microns, in terms of equivalent circle diameter (ECD) as measured by laser diffractometric means. The raw material aggregations used in each of Examples 1, 2 and 3 as well as the control material were provided from the same source. Respective aggregations comprising the cBN grains and aluminium powder were prepared in the form of compacted discs encapsulated within cups of a refractory material, which were assembled into a capsule for sintering PCBN material and subjected to a sinter pressure and a sinter temperature for a sinter time.

Both of the Example 1 and 2 PCBN discs were sintered at a sinter pressure of about 5 gigapascals (GPa), a mean sinter temperature of about 1,650 degrees Celsius (a maximum temperature of about 1,710 degrees Celsius might have been reached)—i.e. about 400 degrees Celsius higher than that used to make the control material—and two different respective sinter periods of about 15 and 47 minutes. The sinter pressure had been increased in order to compensate thermodynamically for the increase in the sinter temperature.

The cBN content in the sintered discs was about 85 mass per cent, the difference between the mass content in the pre-sinter aggregation and in the sintered disc arising substantially from the dissolution of the grains in the aluminium and the subsequent formation of aluminium nitride.

The Example 1 and the control PCBN material were compared by using them to machine grey cast iron suitable for brake discs. Cutter elements comprising each were made by cutting corresponding structures from respective PCBN discs and processing the structures to provide them with cutting edges. The ‘flank wear’ of the Example 1 and control PCBN elements were measured after turning 600 passes, corresponding to about 70 minutes of turning. The flank wear is measured in terms of the size Vb of the wear scar in millimetres (mm) formed on the cutter element during the test.

In the machining test, the mean flank wear on the Example 1 cutter element was about 0.058 millimetres, which was substantially better than the mean flank wear of about 0.11 millimetres (mm) of the control cutter element, the standard deviation being about 0.002 millimetres. In other words, the wear scars of the Example 1 and 2 PCBN elements were about 40 per cent less than that of the control PCBN element.

The speeds of sound of the Example 1 and 2 PCBN materials were about 15,050 metres per second (m/s) and that of the control PCBN material was in the range of 13,600 to 14,350 metres per second (m/s).

The control and Example 1 and 2 PCBN materials were analysed using X-ray diffraction (XRD) and whilst a clear peak corresponding to aluminium diboride was evident in the control sample, there was no evidence of aluminium diboride in the Example 1 and 2 PCBN material within the detection limit estimated to be at most about 1 weight per cent.

### EXAMPLE 3

Example 3 PCBN material was made in substantially the same was as the Example 1 and 2 PCBN materials, except that the sinter period was 27 minutes.

The mean flank wear on the Example 3 cutter element was about 0.058 millimetres, which was substantially better than the mean flank wear of about 0.11 millimetres (mm) of the control cutter element, the standard deviation being about 0.002 millimetres. In other words, the wear scar of the Example 3 PCBN element was about 40 per cent less than that of the control PCBN element.

The speed of sound of the Example 3 PCBN material was about 15.05 to 15.19 metres per second (m/s) and that of the control PCBN material being in the range of 13,60 to 14,35 metres per second (m/s).

The XRD measurement of the control material exhibited a clear peak corresponding to aluminium diboride peak, but there was no evidence of aluminium diboride in the Example 3 PCBN material within the detection limit estimated to be at most about 1 weight per cent.

### EXAMPLES 4 AND 5

Examples 4 and 5 differ from each other only in that the sinter periods used to make the PCBN material were 20 and 47 minutes respectively.

Raw material aggregations were made by blending cBN grains with aluminium (Al) powder having a mean grain size of about 6 microns, the mass content of the cBN being about 91 per cent of the blended powders and the balance consisting of the Al powder. The cBN grains for both the control and Example 4 and 5 materials had been provided from a single plurality of crushed cBN grains having a mean size of about 1 to 5 microns, in terms of equivalent circle diameter (ECD) as measured by laser diffractometric means. The raw material aggregations used in each of Examples 4 and 5 as well as the control material were provided from the same source.

The speeds of sound of the Example 4 and 5 PCBN materials were about 15.20 and 15.26 metres per second (m/s) and the XRD measurement exhibited no AlB₂ peaks and a sharpening of the AlN peaks.

### EXAMPLE 6 AND 7

Examples 6 and 7 differ from each other only in that the sinter periods used to make the PCBN materials were 20 and 47 minutes respectively.

Raw material aggregations were made by blending cBN grains with aluminium (Al) powder having a mean grain size of about 6 microns, the mass content of the cBN being about 87 per cent of the blended powders and the balance consisting of the Al powder. The cBN grains for both the control and example materials had been provided by combining five pluralities of crushed cBN grains, each plurality having a different mean size and equal masses. The cBN grains used in each of Examples 6 and 7, as well as the control material were provided from the same source.

The speeds of sound of the Example 6 and 7 PCBN materials were about 14.79 and 14.18 metres per second (m/s), and peaks corresponding to aluminium diboride were not evident in the XRD measurements, which exhibited sharpening of the AIN peaks.

The cBN contents, sinter periods, approximate sinter temperature, flank wear (for Example 1 and its corresponding control material) and speed of sound in the Example 1 to 7 PCBN materials are summarised in Table 1 below.

TABLE 1

| | Solvent | | | | | |
|---|---|---|---|---|---|---|
| | material | cBN: | Sinter | Sinter | Flank | |
| Example | (liquid | solvent | period, | temp. | wear, | Speed of |
| no. | phase) | mass ratio | min. | ° C. | micron | sound, m/s |
| 1 | Al | 90:10 | 15 | 1,650 | 0.058 | 15.1 |
| 2 | Al | 90:10 | 47 | 1,650 | | 15.2 |
| 3 | Al | 90:10 | 27 | 1,650 | | 15.2 |
| Control A | Al | 90:10 | 30 | 1,250 | 0.11 | 13.6-14.4 |
| 4 | Al | 91:9 | 20 | 1,650 | | 15.2 |
| 5 | Al | 91:9 | 47 | 1,650 | | 15.2 |
| Control B | Al | 91:9 | 30 | 1,250 | | 13.6-14.4 |
| 6 | Al | 87:13 | 20 | 1,650 | | 14.8 |
| 7 | Al | 87:13 | 47 | 1,650 | | 14.2 |
| Control C | Al | 87:13 | 30 | 1,250 | | 14.1-14.7 |

While wishing not to be bound by a particular theory, aluminium boride compounds comprising several boron atoms for each aluminium atom may form less readily than aluminium nitride and it may be that the melting point temperature of aluminium boride compounds increases as the ratio of boron to aluminium atoms increases. So, for example, there may be a range of temperatures (for a given pressure) at which a boron-rich region may remain in the solid state while an adjacent region comprising a lower ratio of boron to aluminium would be in a molten state. In the particular context of a process of making certain PCBN material as previously described, aluminium from the aluminium source may melt as the temperature is increased past its melting point and infiltrate into the cBN aggregation, occupying the interstices between the cBN grains and wetting their surfaces. This process may be accelerated as a result of the applied ultra-high pressure. Boron and nitrogen from the surfaces of the cBN grains will likely dissolve in some form into the molten aluminium and diffuse away from the cBN grains into the interstitial regions. Regions of solid aluminium nitride will likely begin to precipitate and grow where the ratio of boron to aluminium locally is suitable. If the temperature is sufficiently high, boron-rich regions may continue to remain in the liquid state as the aluminium nitride phase progressively extends from the cBN grains, leaving molten boron rich volumes near the centres of the interstitial regions, relatively remote from the cBN grains and separated from them by the aluminium nitride. When the temperature is reduced, the material in the boron-rich volume will solidify to form volumes of solid, potentially amorphous boron-rich grains comprising material in which the ratio of boron to aluminium atoms is at least about 15 or 16, or about 24 to 26 as measured by spot EDS. If the above hypothesis is correct, it may be expected that higher sinter temperatures may result in higher ratios of y to x (i.e. a higher ratio of boron atoms to aluminium atoms). For example, the boron-rich grains may appear in electron backscatter spot analysis as substantially stoichiometric or non-stoichiometric aluminium hexadecaboride or aluminium pentacotsaboride. Additionally, relatively longer sinter times may result in less finely dispersed boron-rich material within the aluminium nitride cementing material, since longer sinter times may likely allow more of the boron to diffuse through the aluminium nitride and combine with the relatively large boron-rich regions relatively remote from the cBN grains (the boron may diffuse through the aluminium nitride in the form of the compound aluminium diboride).

While wishing not to be bound by a particular theory, it may be hypothesised that the presence of the microscopic grains of boron-rich aluminium boride phases within a substantially aluminium nitride matrix between the cBN grains may have the effect of strengthening the matrix and making it more resistant to abrasive wear, or some other advantageous effect. For example, in one hypothesis, their presence may result in the formation of a thin film of glassy boron oxide phase on part of the surface of the PCBN material, such as over the cBN grains, when the PCBN material is used to machine a work-piece. Such machining often generates substantial heat on the PCBN cutting edge, which may result in the oxidation of some of the boron and the resulting boron oxide material may be in a molten or plastic state at or adjacent the cutting edge. This may have the effect of lubricating the cutting edge and work-piece to some extent during the machining process, and or it may enhance the machining process in some way.

Certain terms and concepts as used herein are briefly explained below.

A machine tool is a powered mechanical device, which may be used to manufacture components comprising materials such as metal, composite materials, wood or polymers by machining, which is the selective removal of material from a body, called a work-piece. A cutter insert may be attached to a machine tool to engage and cut the work-piece. A rake face of a cutter insert is the surface or surfaces over which the chips from the work-piece flow, the rake face directing the flow of newly formed chips. Chips are the pieces of a body removed from the work surface of the body by a machine tool in use. The flank of a cutter insert is the surface that passes over the machined surface produced on the body by the cutter insert. The flank may provide a clearance from the body and may comprise more than one flank face. A cutting edge is the edge of a rake face intended to perform cutting of a body.

In rough machining operations, the feed rate and depth of cut are relatively high and the load on the cutting edge of the tool is high, often in the range of about 5 to 10 kN (kilonewtons). Rough machining is frequently undertaken on work-pieces which include an “interrupt” aspect, which may be intentional or unintentional. For example, an interrupt may be in the form of a “V” groove or porosity from gases evolved during casting, slag or sand particles. In rough machining, dimensional tolerance is not as critical as in finishing operations and flank wear values up to and in excess of 1 mm may be permitted. Consequently, it is likely that chip resistance rather than wear is the dominant failure mode in rough machining.

As used herein, a material that “substantially consists of” certain constituents means that the material consists of the constituents apart from minor amounts of practically unavoidable impurities.

As used herein, references to atoms are to the presence of any isotope of the corresponding atomic nuclei, regardless of whether the atom is in ionic or neutral form, or whether the atom is bonded to one or more other atoms in a chemical compound.

As used herein, a mode of a distribution is a local maximum value, occurring more frequently in the data than do other values within a range including the mode. Visually, a mode in a size distribution graph will be evident as a peak. For example, in a mono-modal distribution, only one peak is evident and there are no local maxima, or only very minor and insubstantial other peaks; in a bi-modal distribution, there are two and only two peaks evident, one of which may be a global maximum and the other may be a local maximum, or both may be substantially equal in frequency. In general, multi-modal distributions comprise at least two modes.

1. PCBN material comprising at least 30 volume per cent cubic boron nitride (cBN) grains bonded together by a matrix comprising aluminium nitride and a plurality of regions comprising boron and aluminium atoms, in which regions there are at least 15 times more boron atoms than aluminium atoms present.

2. PCBN material as claimed in claim 1, in which the regions comprise an aluminium boride phase of the inorganic chemical formula AlxBy, where x is at least 0.8 and at most 1.2, and y is at least 15, the ratio y:x being at least 15.

3. PCBN material as claimed in claim 2, in which x is 1 and y is has a mean value in the range 16 to 16.5.

4. PCBN material as claimed in claim 2, in which x is 1 and y has a mean value in the range 24 to 26.

5. PCBN material as claimed in claim 1, in which the regions are substantially amorphous.

6. PCBN material as claimed in claim 1, in which the regions comprise an aluminium boride phase, the content of which is at least 1 weight per cent of the PCBN material.

7. PCBN material as claimed in claim 1, in which the cBN grains have a mean size of at least 0.5 microns and at most 10 microns.

8. PCBN material as claimed in claim 1, in which the mass distribution of cBN grains as a function of cBN grain size includes more than one mode.

9. PCBN material as claimed in claim 1, substantially free of aluminium diboride.

10. PCBN material as claimed in claim 1, in which the regions are separated from the cBN grains by matrix material comprising aluminium nitride.

11. PCBN material as claimed in claim 1, having porosity less than 1 per cent.

12. (canceled) PCBN material as claimed in any of the preceding claims, having a microstructure such that the mean speed of sound through the material is at least 14,500 metres 10 per second (m/s).

13. A method of making PCBN material as claimed in any of the preceding claims, the method including a pre-sinter compact comprising an aggregation comprising a plurality of cBN grains, and a source of aluminium, the source being selected and arranged in relation to the aggregation such that molten aluminium will be available to contact the cBN grains at a sinter temperature of at least 1,500 degrees Celsius and a sinter pressure of at least 4.5 gigapascals (GPa), subjecting the pre-sinter compact to the sinter temperature and sinter pressure for sufficient sinter period for the aluminium to react with the cBN grains to the extent that there remains substantially no non-reacted aluminium between the cBN grains and to provide a sintered PCBN structure, the sinter pressure and sinter temperature selected such that substantially no hexagonal boron nitride (hBN) arises in the sintered PCBN structure; and then decreasing the temperature and pressure to an ambient condition; the amount and size distribution of the cBN grains comprised in the aggregation being such that the content of the cBN grains in the PCBN material will be at least 30 volume per cent.

14. A method as claimed in claim 12, in which the sinter temperature at least 1,800 degrees Celsius.

15. A method as claimed in claim 12, in which the sinter pressure is at least 5 gigapascals (GPa)

16. A method as claimed in claim 12, in which the sinter pressure is at least 6 gigapascals (GPa).

17. A method as claimed in claim 12, in which the mass distribution as a function of grain size of the cBN grains comprised in the aggregation includes more than one mode.

18. A method as claimed in claim 12, in which the source of aluminium is in the form of grains of aluminium metal blended with the cBN grains comprised in the aggregation.

19. A tool comprising PCBN material as claimed in claim 1.

20. A method of using a machine tool comprising PCBN material as claimed in claim 1, including providing a machine tool comprising a cutter edge defined by the PCBN material, and using the tool to machine a body comprising cast iron material.
